(19) United States
(12) Patent Application Publication
(10) Pub. No.: US 2012/0062715 A1
(43) Pub. Date: Mar. 15, 2012

(54) WIRELESS ENDOSCOPIC APPARATUS, RECEIVING DEVICE THEREOF, AND RECEIVING METHOD

(75) Inventors: Takahisa Endo, Tokyo (JP); Takemitsu Honda, Tokyo (JP)

(73) Assignees: OLYMPUS MEDICAL SYSTEMS CORP., Tokyo (JP); OLYMPUS CORPORATION, Tokyo (JP)

(21) Appl. No.: 13/321,704

(22) PCT Filed: Apr. 19, 2010
(86) PCT No.: PCT/JP2010/002821

§ 371 Date: Nov. 21, 2011

(30) Foreign Application Priority Data
Jun. 10, 2009 (JP) 2009-139420

(51) Int. Cl. H04N 7/18

(52) U.S. Cl. 348/65; 348/E07.085

(57) ABSTRACT

A receiving device of a wireless endoscopic apparatus includes a communication unit, a storage unit, and a determination unit. The communication unit communicates with a transmitting device using a communication channel selected from among n (n>1) communication channels each having a use frequency band partially overlapping with that of at least one of other communication channels, and receives image data transmitted from the transmitting device. The storage unit stores x (1<x≦n) communication channel groups to which L (1≦L<n) communication channels belong. The determination unit selects an arbitrary defined communication channel group from among the communication channel groups stored by the storage unit, and detects the usage state of a communication channel belonging to the selected communication channel group. On the basis of the result of the detection, the determination unit determines whether or not to perform communication using the communication channel belonging to the selected communication channel group.

### TECHNICAL FIELD

The present invention relates to a wireless endoscopic apparatus, a receiving device thereof, and a receiving method.

Priority is claimed on Japanese Patent Application No. 2009-139420, filed Jun. 10, 2009, the content of which is incorporated herein by reference.

### BACKGROUND ART

In recent years, endoscopic apparatuses that enable a subject image of an inside of a body cavity or a conduit to be observed by inserting an elongated insert member into the body cavity or the conduit have been widely used. In general, the above-described endoscopic apparatus includes an endoscope having the insert member to be inserted into the body cavity or the conduit and a main body device having a light source device or a video processor. The endoscope and the main body device are connected by a light guide cable, which guides illumination light from the light source device to the endoscope, and a signal cable, which transmits an image pickup signal obtained by the endoscope to the video processor. Thereby, a moving range of the endoscope is limited and the operability of the endoscope is hindered.

For example, in Patent Document 1, an illumination device constituted by a light emitting diode (LED) and the like is embedded in the endoscope, so that the light guide cable extending from the endoscope is removed. A video signal processing circuit, which obtains a video signal capable of being displayed on a monitor by performing video signal processing of an image pickup signal, and a transmitting circuit, which transmits the video signal by an radio wave, are provided in the endoscope, and a receiving device, which receives the radio wave and demodulates the video signal, is provided separately from the endoscope so that the signal cable extending from the endoscope is removed. In general, the above-described endoscopic apparatus is also referred to as a wireless endoscopic apparatus, and has an advantage in that the limitation of a moving range of the endoscope is mitigated and the operability thereof is improved.

### Citation List

Patent Document 1: Japanese Unexamined Patent Application, First Publication, No. S60-4811

### SUMMARY OF INVENTION

### Problems to be Solved by the Invention

Because the receiving device is provided separately from the endoscope in the wireless endoscopic apparatus, it is necessary to set up a communication channel of the endoscope of a transmitting side in accordance with a communication channel set in the receiving device and establish a connection of wireless communication. A method of uniquely determining a combination of the receiving device and the endoscope and fixedly pre-setting a communication channel to an arbitrary communication channel is also possible. However, because disinfection/sterilization treatments and examinations of the endoscopes are simultaneously processed in a hospital using a plurality of receiving devices and a plurality of endoscopes, the combination of the receiving device and the endoscope is not uniquely determined. In order to prevent the interference of radio waves, it is necessary to set communication channels of the receiving devices to be different from each other.

Thus, a switch for selecting a communication channel is provided in each of the receiving device and the endoscope, and the same communication channel as the communication channel set in the receiving device of an object to be used at the initiation of use of the endoscopic apparatus is set in the endoscope of an object to be used, so that a wireless communication connection between the receiving device and the endoscope is established.

In data communication to be performed by a general personal computer via a wireless LAN, a connection to the wireless LAN is established by a method of selecting a wireless terminal (AP) to be connected by a user after detecting a connectable wireless terminal (AP) by searching for all available communication channels. in recent years, a function of searching for all communication channels available in a wireless LAN at power-up, detecting empty communication channels unused by other wireless terminals, and automatically setting up a communication channel from the empty communication channels has been provided in a household wireless LAN AP. As described above, because a communication channel to be connected is determined in the wireless LAN of a general personal computer after all available communication channels are searched for, it takes time for the connection to be established.

On the other hand, efficiently selecting a communication channel having a good communication state is a goal to improve the operability in a communication connection of the endoscopic apparatus.

The present invention has been made in view of the above-described problems, and an object of the invention is to provide a wireless endoscopic apparatus, a receiving device thereof, and a receiving method capable of efficiently selecting a communication channel of which a communication state is good.

### Means for Solving the Problems

According to the present invention for solving the above-described problem, there is provided a receiving device of a wireless endoscopic apparatus including: a communication unit for communicating with a transmitting device by use of a communication channel selected from among n (n>1) communication channels each having a use frequency band partially overlapping that of at least one other communication channel, and receiving image data transmitted from the transmitting device; a storage unit for storing x (1<x≦n) communication channel groups to which L (1≦L<n) communication channels belong; and a determination unit for selecting any communication channel group from among the communication channel groups stored by the storage unit, detecting use states of communication channels belonging to the selected communication channel group, and determining whether or not to perform communication using a communication channel belonging to the selected communication channel group on the basis of a detection result.

The receiving device of the wireless endoscopic apparatus of the present invention may further include: an output unit for outputting information for prompting selection of a communication channel group different from the selected communication channel group if the determination unit determines not to perform the communication.

In the receiving device of the wireless endoscopic apparatus of the present invention, the output unit may output information regarding a use state of a communication channel to perform the communication if the determination unit determines to perform the communication.

The receiving device of the wireless endoscopic apparatus of the present invention may further include: a operation unit for allowing an operator to select a communication channel group and transferring a selection result to the determination unit.

In the receiving device of the wireless endoscopic apparatus of the present invention, the determination unit may detect communication traffic of a communication channel belonging to the selected communication channel group as the use state.

In the receiving device of the wireless endoscopic apparatus of the present invention, the determination unit may detect received signal strength of a communication channel belonging to the selected communication channel group as the use state.

In the receiving device of the wireless endoscopic apparatus of the present invention, the determination unit may determine whether or not to perform communication using the communication channel belonging to the selected communication channel group on the basis of presence of a communication channel of which the communication traffic is less than a predetermined threshold.

In the receiving device of the wireless endoscopic apparatus of the present invention, the determination unit may determine whether or not to perform communication using the communication channel belonging to the selected communication channel group on the basis of presence of a communication channel of which the received signal strength is less than a predetermined threshold.

In the receiving device of the wireless endoscopic apparatus of the present invention, the determination unit may determine to perform communication using a communication channel belonging to a communication channel group having a smallest total of communication traffic of communication channels belonging to the same communication channel group.

In the receiving device of the wireless endoscopic apparatus of the present invention, the storage unit may store a communication channel group to which a communication channel having a use frequency band not overlapping that of a specific communication channel belonging to which another communication channel group belongs.

In the receiving device of the wireless endoscopic apparatus of the present invention, the storage unit may store a communication channel group to which a communication channel having an overlap of a use frequency band with that of a specific communication channel belonging to the same communication channel group belongs, wherein the overlap is equal to or greater than a predetermined range.

According to the present invention, there is provided a receiving method for use in a receiving device of a wireless endoscopic apparatus, including the steps of: selecting any communication channel group from among x (1<x≦n) communication channel groups to which L (1≦L<n) communication channels belong among n (n>1) communication channels each having a use frequency band partially overlapping that of at least one other communication channel; detecting use states of communication channels belonging to the selected communication channel group; determining whether or not to perform communication using a communication channel belonging to the selected communication channel group on the basis of a detection result; and communicating with a transmitting device by use of the communication channel when determining whether to perform the communication using the communication channel belonging to the selected communication channel group, and receiving image data transmitted from the transmitting device.

A wireless endoscopic apparatus includes a receiving device and a transmitting device, wherein: the receiving device includes: a first communication unit for communicating with a transmitting device by use of a communication channel selected from among n (n>1) communication channels each having a use frequency band partially overlapping that of at least one other communication channel, and receiving image data transmitted from the transmitting device; a storage unit for storing x (1<x_{≦}n) communication channel groups to which L (1≦L<n) communication channels belong; and a determination unit for selecting any communication channel group from among the communication channel groups stored by the storage unit, detecting use states of communication channels belonging to the selected communication channel group, and determining whether or not to perform communication using a communication channel belonging to the selected communication channel group on the basis of a detection result, and the transmitting device includes: a second communication unit for communicating with the receiving device by use of a communication channel selected from among n communication channels and transmitting the image data to the receiving device.

### Effect of the Invention

According to the present invention, it is possible to efficiently select a communication channel of which a communication state is good by detecting use states of communication channels belonging to a selected communication channel group and determining whether or not to perform communication using a communication channel belonging to the selected communication channel group on the basis of a detection result, as compared to the case where all communication channels are searched for.

### BRIEF DESCRIPTION OF THE DRAWINGS

FIG 1. is a configuration diagram showing a configuration of an endoscopic apparatus according to an embodiment of the present invention.

FIG. 2 is an external appearance diagram of an endoscope according to an embodiment of the present invention.

FIG. 3 is a block diagram showing a configuration of the endoscope according to an embodiment of the present invention.

FIG. 4 is a block diagram showing a configuration of a receiving device according to an embodiment of the present invention.

FIG. 5 is a flowchart showing an operation of the receiving device according to an embodiment of the present invention.

FIG. 6 is a flowchart showing an operation of the receiving device according to an embodiment of the present invention.

FIG. 7 is a flowchart showing an operation of a logical connection according to an embodiment of the present invention.

FIG. 8 is a flowchart showing an operation of the endoscope according to an embodiment of the present invention.

FIG. 9 is a flowchart showing an operation of the receiving device according to an embodiment of the present invention.

FIG. 10 is a flowchart showing an operation of the receiving device according to an embodiment of the present invention.

FIG. 11 is a flowchart showing an operation of the receiving device according to an embodiment of the present invention.

FIG. 12 is a reference diagram showing content of a communication channel setting table according to an embodiment of the present invention.

FIG. 13 is a reference diagram showing content of a search table according to an embodiment of the present invention.

FIG. 14 is a reference diagram showing content of a communication channel setting table according to an embodiment of the present invention.

FIG. 15 is a reference diagram showing content of a search table according to an embodiment of the present invention.

FIG. 16 is a reference diagram showing a frequency band in which a communication channel is used.

FIG. 17 is a reference diagram showing a frequency band in which a communication channel is used.

FIG. 18 is a reference diagram showing a frequency band in which a communication channel is used.

### BEST MODE FOR CARRYING OUT THE INVENTION

Hereinafter, the present invention will be described with reference to specific embodiments. Those skilled in the art may adopt a variety of different embodiments based on the description of the present invention, and the invention is not limited to the embodiments shown for the sake of description.

Hereinafter, the embodiments of the present invention will be described with reference to the drawings. As described above, to improve operability in a communication connection of an endoscopic apparatus, efficiently selecting a communication channel having a good communication state is a goal. Another goal is to implement power saving by shortening the connection waiting time of an endoscope driven by a battery. As described below, there is a problem in that a communication error occurs due to a frame collision in the endoscopic apparatus.

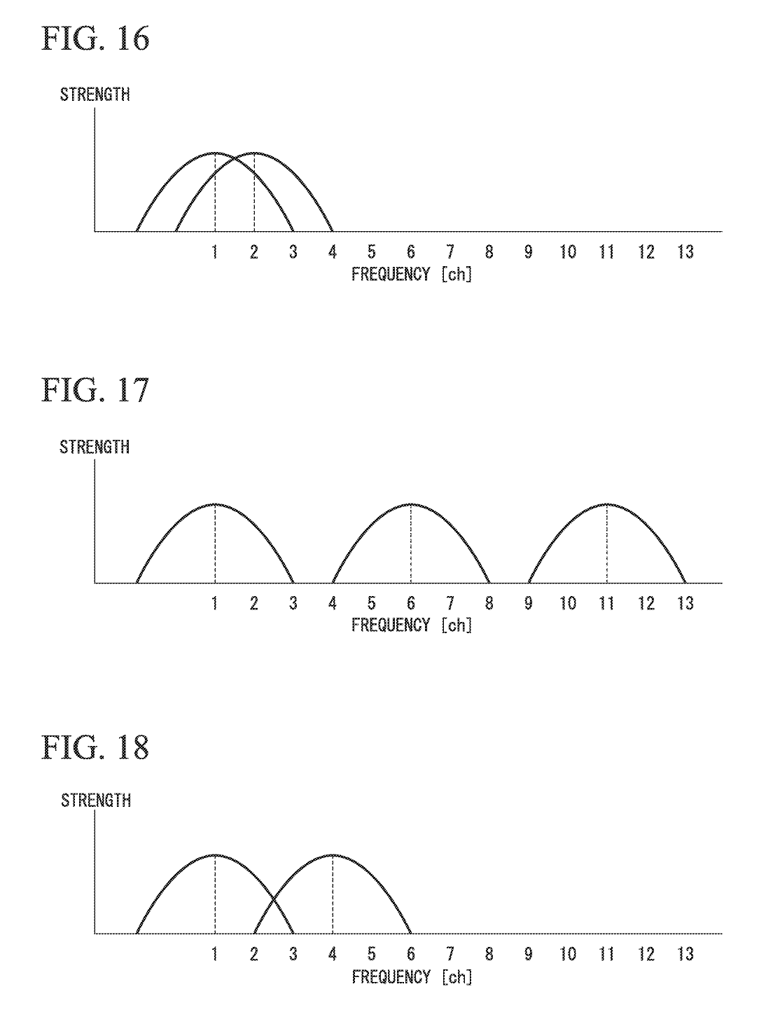

As a communication system to be used in wireless communication, it is effective to use a wireless communication system such as IEEE 802.11 used in a wireless LAN in which high-speed data communication is possible. In the wireless communication system, the wireless communication is performed by selecting any communication channel from a plurality of communication channels so as to effectively use a frequency band. As shown in FIG. 16, each communication channel is arranged to have a use frequency band of which a part thereof overlaps that of another communication channel due to a limit of an available frequency band.

In data communication within a set communication channel, a process of avoiding a collision between transmission frames is performed by control of IEEE 802.11 protocol. However, if another wireless terminal performs data communication by a communication channel adjacent to the set communication channel, the process of avoiding a collision with a transmission frame of an adjacent communication channel does not work because the endoscopic apparatus does not recognize the transmission frame of the adjacent communication channel.

Thus, there is a problem in that a frame collision occurs if a transmission frame from the endoscope and a transmission frame from a wireless terminal using a communication channel adjacent to a communication channel used by the endoscope are transmitted at the same timing. If a radio wave output of the wireless terminal is large, there is a problem in that the receiving device does not normally receive image data transmitted from the endoscope and hence an image thereof is interrupted.

In data communication performed by a general personal computer via the wireless LAN, the occurrence of a communication error does not become a large problem when a data arrival by retransmission is ensured because a delay of data communication is allowed to a certain extent. In order to cause a large number of wireless LANs to co-exist, it is necessary to efficiently allocate a communication channel rather than to avoid the occurrence of a communication error due to a temporary frame collision. A communication channel to be used is determined on the basis of a determination of only whether or not the communication channel to be used is used in other communication terminals.

On the other hand, in the endoscopic apparatus, it is important to transmit/receive all image data of a communication object without loss or delay so as to ensure operability and it is necessary to perform wireless communication at a low communication error rate by selecting a communication channel having a good wireless environment. Thus, the occurrence of a communication error due to a frame collision with a communication channel adjacent to a communication channel used by the endoscopic apparatus is problematic.

In view of the above, the endoscopic apparatus (wireless endoscopic apparatus) according to this embodiment implements power saving and reduces the occurrence of a communication error by efficiently selecting a communication channel having a good communication state. In this embodiment, it is assumed that IEEE 802.11 is used as an example of the wireless communication system.

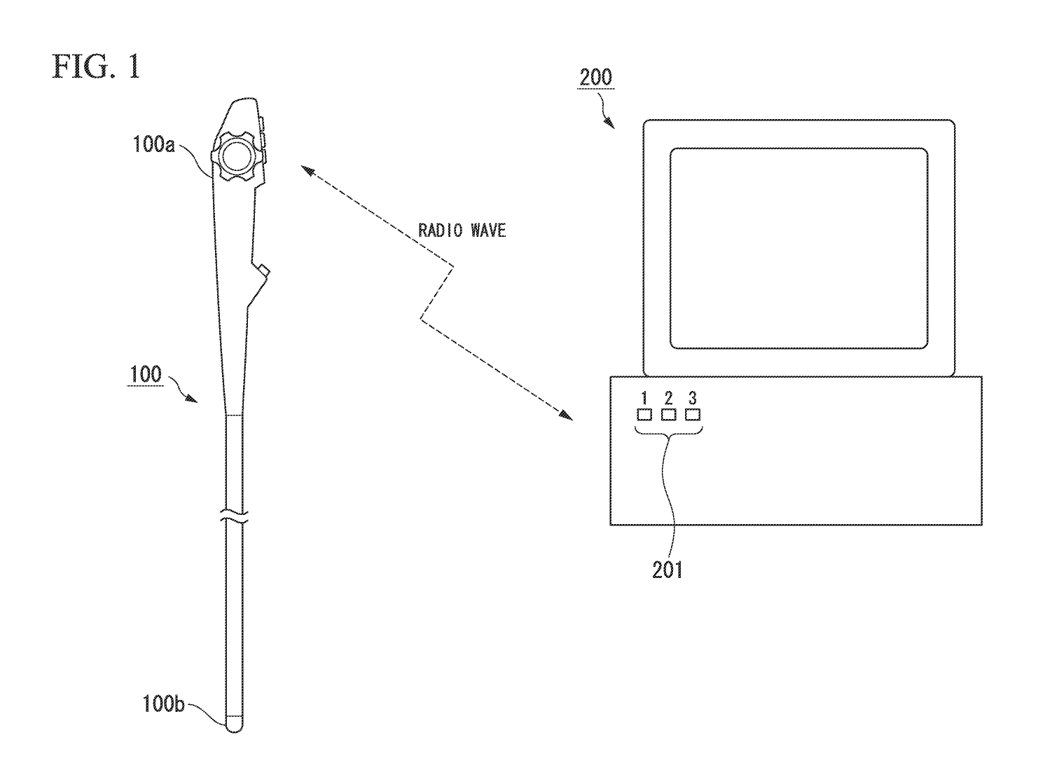

FIG. 1 shows a configuration of an endoscopic apparatus according to this embodiment. The endoscopic apparatus includes an endoscope 100, which transmits captured image data by wireless communication, and a receiving device 200, which receives the image data transmitted from the endoscope 100 and displays an image on a monitor. The endoscope 100 includes an operation unit 100a including a plurality of switches for allowing an operator to input an operating instruction. The receiving device 200 includes a communication setting display unit 201 including a plurality of LEDs, which indicate a communication setting state of the receiving device 200. Although not shown in FIG. 1, a CH (channel) setting switch is mounted on the back of the receiving device 200.

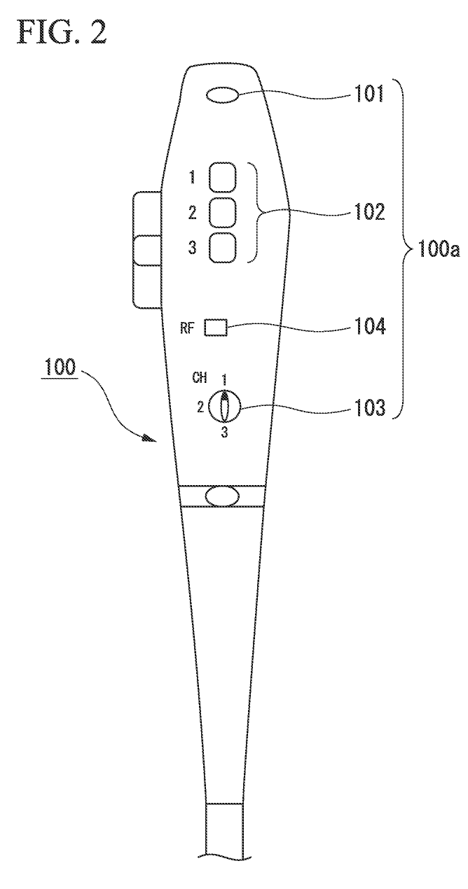

FIG. 2 shows a state of the endoscope 100 when viewed from a layout surface of operating switches. An operation unit 100a of the endoscope 100 includes a power switch 101, a plurality of operating switches 102, a CH setting switch 103, and a state indication LED 104. A number for identifying a set CH is assigned to the CH setting switch 103.

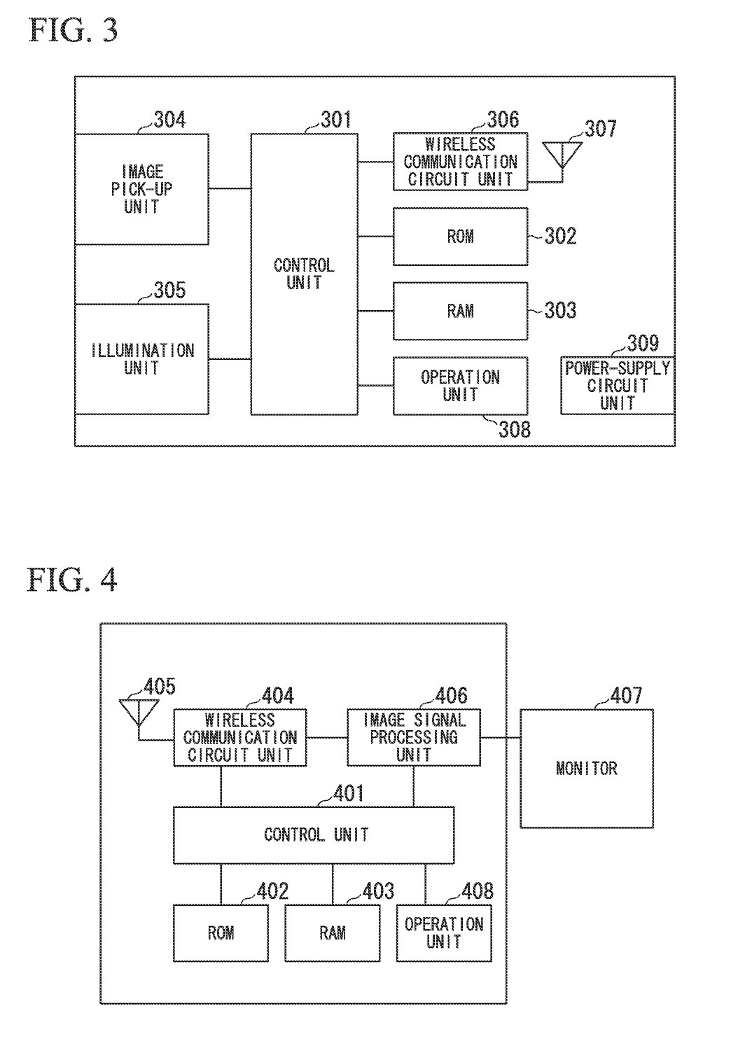

FIG. 3 shows an electrical configuration of the endoscope 100. The endoscope 100 includes a control unit 301, a ROM 302, a RAM 303, an image pickup unit 304, an illumination unit 305, a wireless communication circuit unit 306, an antenna 307, an operation unit 308, and a power-supply circuit unit 309.

The control unit 301 operates according to a program stored in the ROM 302, and controls an operation sequence of the endoscope 100. The ROM 302 is a non-volatile memory such as a flash ROM. Program data for controlling the endoscope 100 and various setting information including communication setting parameters are stored in the ROM 302. The communication setting parameters include a communication channel (frequency), a service set identifier (SSD)), wired equivalent privacy (WEP), and the like corresponding to each number assigned to the CH setting switch 103.

The RAM 303 is used as a buffer, which temporarily buffers image data output from the image pickup unit 304, a work area to be used in an arithmetic operation and the like of the control unit 301, and an area where various settings and the like are temporarily stored.

The image pickup unit 304 includes a lens, which forms an image of incident light, a photoelectric converter (a CCD or CMOS sensor, or the like), which converts light of which an image is formed into an electric signal, an analog-to-digital (AD) converter, which converts an analog electric signal output from the photoelectric converter into a digital electric signal, and the like.

The illumination unit 305 includes an irradiation lens, an LED, an LED drive circuit, and the like, and is arranged on a tip end 100b (FIG. 1) of the endoscope 100. Light emitted from the LED is irradiated to a body to be observed within a body cavity via the irradiation lens. The illumination unit 305 may have a configuration that the LED is arranged inside the operation unit 100a, not on the tip end 100b, and light is guided to the tip end 100b by a light guide.

The wireless communication circuit unit 306 includes a high-frequency circuit unit necessary for wireless communication, an encoding/decoding circuit unit, a buffer memory, and the like, and is connected to the antenna 307. To perform wireless communication with the receiving device 200, it is necessary to set the CH setting switch 103 to the same number as that of a CH setting switch set in the receiving device 200 so as to set the same communication channel, SSID, and the like as those set in the receiving device 200. Communication setting parameters corresponding to a communication channel designated by each number of the CH setting switch 103 are set in the wireless communication circuit unit 306.

The operation unit 308 (corresponding to the operation unit 100a of FIG. 1) has the power switch 101, the operating switch 102, and the CH setting switch 103 shown in FIG. 2, and outputs states and state variations of buttons and switches as electric signals. The state indication LED 104 for providing notification of a state of a connection to the receiving device 200 is arranged in the operation unit 308.

The power-supply circuit unit 309 includes a battery, a DC/DC converter, and the like, and supplies power to each block described above by sensing the turn-on of the power switch 101.

FIG. 4 shows an electrical configuration of the receiving device 200. The receiving device 200 includes a control unit 401, a ROM 402, a RAM 403, a wireless communication circuit unit 404, an antenna 405, an image signal processing unit 406, a monitor 407, and a operation unit 408.

The control unit 401 operates according to a program stored in the ROM 402, and controls an operation sequence of the receiving device 200. The ROM 402 is a non-volatile memory of a flash ROM or the like. Program data for controlling the receiving device 200, various setting information including communication setting parameters, a communication channel setting table, and a search table are stored in the ROM 402.

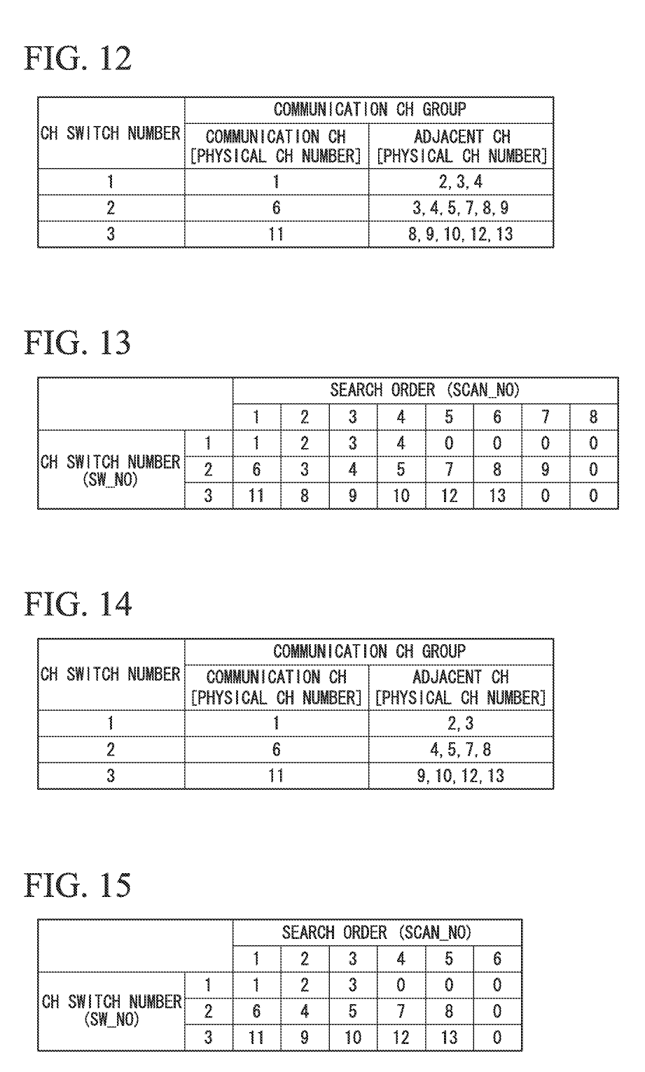

FIG. 12 shows content of the communication channel setting table. In the communication channel setting table, a communication channel number is associated with each number of a CH setting switch (a CH switch number). In IEEE 802.11, it is possible to perform wireless communication by selecting any communication channel from a plurality of communication channels. Although center frequencies of communication channels are separated by 5 MHz from each other, an overlap of a use frequency band occurs between adjacent communication channels as shown in FIG. 16 because each communication channel uses a frequency band of about 20 MHz.

In this embodiment, 13 communication channels are provided. Each of the 13 communication channels belongs to at least one of 3 communication channel groups corresponding to CH switch numbers. For example, a communication channel group including communication channels 1, 2, 3, and 4 corresponds to a CH switch number 1, a communication channel group including communication channels 3, 4, 5, 6, 7, 8, and 9 corresponds to a CH switch number 2, and a communication channel group including communication channels 8, 9, 10, 11, 12, and 13 corresponds to a CH switch number 3.

One communication channel of the communication channels belonging to each communication channel group is used in a logical connection to be described later. For example, if the CH switch number 1 is set, the communication channel 1 is used in the logical connection. If the CH switch number 2 is set, the communication channel 6 is used in the logical connection. If the CH switch number 3 is set, the communication channel 11 is used in the logical connection. The communication channels 1, 6, and 11 are the same as communication channels set by the CH setting switch 103 in the endoscope 100. As shown in FIG. 17, frequency bands of the communication channels 1, 6, and 11 do not overlap. One communication channel group includes one communication channel (written as a communication channel in FIG. 12) used in the logical connection and communication channels (written as adjacent CHs in FIG. 12) each having a use frequency band partially overlapping that of the one communication channel.

When the above is more generalized, n (n>1) communication channels each having a use frequency band partially overlapping that of at least one other communication channel are provided, and x (1<x≦n) communication channel groups to which L (1≦L<n) communication channels belong are provided. In an example shown in this embodiment, n=13, L=4 (the CH switch number 1), 7 (the CH switch number 2), and 6 (the CH switch number 3), and

FIG. 13 shows content of the search table. In the search table, a search order and a communication channel number belonging to each communication channel are associated with each CH switch number. Although there is the search order in which 0 is stored as the communication channel number, 0 is a value used to determine an end of a search phase to be described later. In the search phase, a use state of a communication channel is detected in order according to the search order.

Returning to the description of a configuration shown in FIG. 4, the RAM 403 is used as a buffer, which temporarily buffers image data received by the wireless communication circuit unit 404, a work area to be used in an arithmetic operation and the like of the control unit 401, and an area where various settings and the like are temporarily stored.

The wireless communication circuit unit 404 includes a high-frequency circuit unit necessary for wireless communication, an encoding/decoding circuit unit, a buffer memory, and the like, and is connected to the antenna 405. Like the wireless communication circuit unit 306 of the endoscope 100, the wireless communication circuit unit 404 performs wireless communication according to a protocol of the wireless LAN. A communication channel designated by a CH switch number set by the CH setting switch is read from the communication channel setting table of FIG. 12, and communication setting parameters corresponding to the communication channel are set in the wireless communication circuit unit 404.

The image signal processing unit 406 converts image data received by the wireless communication circuit unit 404 into a National Television System Committee (NTSC) signal or a Phase Alternating Line (PAL) signal, and outputs it to the monitor 407. The monitor 407 includes a liquid crystal display (LCD) device and its control circuit, displays an image, and operates as a notification unit for providing notification of a state of a wireless connection.

Although not shown in FIG. 1, the operation unit 408 has a CH setting switch mounted on the backside of the receiving device 200, and outputs a state and a state variation of the CH setting switch as an electric signal. Also, the communication setting display unit 201 (FIG. 1), which indicates a communication channel selected by the CH setting switch by an LED, is arranged in the operation unit 408.

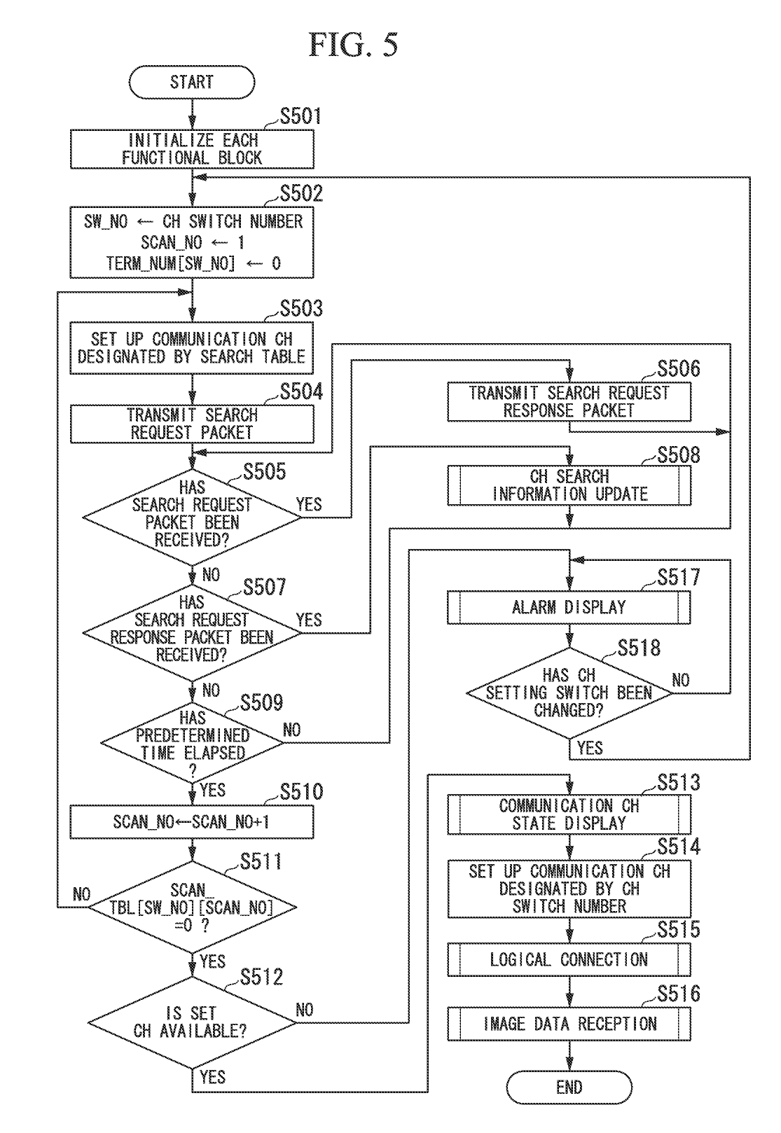

Next, an operation of the endoscopic apparatus according to this embodiment will be described. Hereinafter, four operation examples will be described. First, a first operation example will be described. Hereinafter, an operation of the receiving device 200 will be described according to FIG. 5. In this embodiment, it is assumed that the operator turns on power of the endoscope 100 to be used after the power of the receiving device 200 to be used is turned on.

The operator turns on the power of the receiving device 200 after setting a communication channel by the CH setting switch of the receiving device 200. If the receiving device 200 is powered on, the control unit 401 initializes each functional block of the receiving device 200 (step S501). At this time, an LED corresponding to a set communication channel among the LEDs of the communication setting display unit 201 is turned on to indicate communication setting set by the CH setting switch of the receiving device 200.

Subsequently, the control unit 401 initializes parameters SW_NO, SCAN_NO, and TERM_NUM[SW_NO] to be later used in control (step S502). SW_NO is a parameter for storing a CH switch number, and is stored as a CH switch number set by the CH setting switch during initialization. SCAN_NO is a parameter for storing a search order in the search table, and is stored as 1 during the initialization. TERM NUM[SW_NO] is a parameter for storing the number of peripheral wireless communication terminals using a communication channel satisfying a predetermined condition, and is stored as 0 during the initialization. TERM_NUM[SW_NO] includes three values of TERM_NUM[1], TERM_NUM[2], and TERM NUM[3].

Subsequently, the receiving device 200 establishes a physical connection of wireless communication by a communication channel selected by the operator as follows. In the physical connection, a radio frequency and an SSID to be used in a connection in a physical layer are determined, and a state is reached in which a packet to be transmitted/received to/from a communication partner is input to hardware. First, the receiving device 200 performs the transition to a search phase of a communication channel.

Upon transition to the search phase, the control unit 401 reads a number of a communication channel (a communication channel for which the CH switch number is SW_NO and the search order is SCAN NO) designated by SW_NO and SCANNO^{.} from the search table, reads communication setting parameters corresponding to the communication channel from the ROM 402, and sets the communication parameters to the wireless communication circuit unit 404 (step S503). In a communication channel search, a search request packet is transmitted and a search request response packet to the search request packet is received during a predetermined period. Thus, the control unit 401 causes the wireless communication circuit unit 404 to transmit the search request packet in a broadcast scheme (step S504). A communication terminal in which the same communication channel as that of the receiving device 200 is set receives the search request packet transmitted from the receiving device 200, and transmits the search request response packet.

After transmission of the search request packet, the control unit 401 determines whether or not a search request packet from another wireless communication terminal has been received (step S505). If the search request packet has been received, the control unit 401 causes the wireless communication circuit unit 404 to transmit a search request response packet in a unicast scheme (step S506). Thereafter, the process returns to step S505. If the packet request packet has not been received, the control unit 401 determines whether or not a search request response packet from another wireless communication terminal has been received (step S507). If the search request response packet has been received, the control unit 401 executes a process of updating the value of TERM_NUM[SW_NO] (CH search information) (step S508). Thereafter, the process returns to step S505. If the search request response packet has not been received, the process moves to step S509.

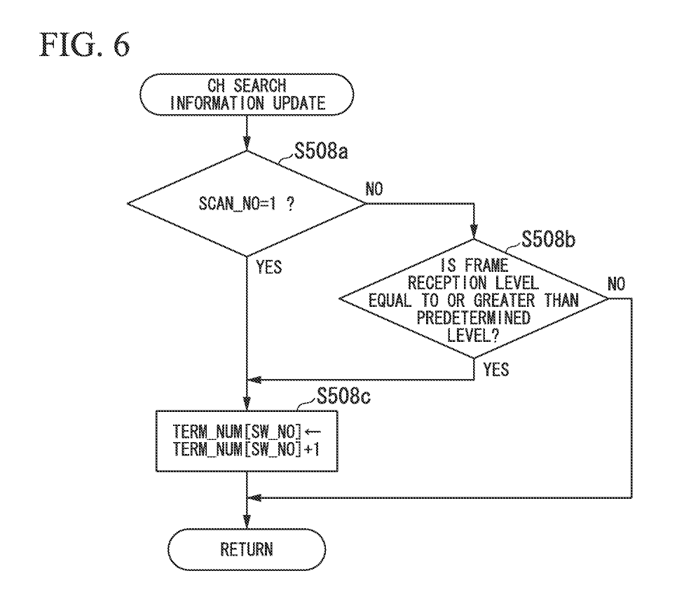

FIG. 6 shows details of step S508. The control unit 401 determines whether or not the value of SCAN_NO is 1 (step S508a). If the value of SCAN_NO is 1, the process proceeds to step S508c. If the value of SCAN_NO is not 1, the control unit 401 determines whether or not a reception level (received signal strength) of a frame of the search request response packet is equal to or greater than a predetermined level (step S508b). If the frame reception level is equal to or greater than the predetermined level, the process proceeds to step S508c. If the frame reception level is less than the predetermined level, the process returns to step S505. If the process proceeds to step S508c, the control unit 401 adds Ito the value of TERM_NUM[SW_NO], and updates the value (step S508c). After the process of step S508c, the process returns to step S509.

The value of TERM_NUM[SW_NO] indicates the number of peripheral wireless communication terminals using the same communication channel (any one of the communication channels 1, 6, and 11) as the communication channel set by the CH setting switch or using a communication channel having a use frequency band overlapping that of the communication channel set by the CH setting switch. If the value of SCAN_NO is 1 in step S508a, another wireless communication terminal uses the same communication channel as the communication channel set by the CH setting switch. If the frame reception level is equal to or greater than the predetermined level in step S508b, another wireless communication terminal uses a communication channel having a use frequency band overlapping that of the communication channel set by the CH setting switch. Although a common threshold is set as a threshold of the frame reception level in each adjacent CH in this embodiment, a predetermined reception level threshold may be set for each adjacent CH.

If the process has proceeded to step S509, the control unit 401 determines whether or not a predetermined time has elapsed after the transmission of the search request packet step S504 (step S509). If the predetermined time has not elapsed, the process returns to step 505. If the predetermined time has elapsed, the control unit 401 adds 1 to the value of SCAN NO, and updates the value (step S510).

Subsequently, the control unit 401 reads a number of a communication channel (a communication channel for which the CH switch number is SW NO and the search order is SCAN_NO) designated by SW_NO and SCAN_NO after update from the search table, and determines whether or not the number is 0 (step S511). If the number of the communication channel designated by SW_NO and SCAN_NO after the update is not 0, the process returns to step S503. If the number of the communication channel designated by SW_NO and SCAN_NO after the update is 0, the control unit 401 determines whether or not the communication channel set by the CH setting switch is available (step S512).

In this embodiment, if the number of wireless terminals, TERM NUM[SW NO], counted in step S508 is less than a predetermined threshold, the control unit 401 determines that the communication channel set by the CH setting switch is available. If it is determined that the communication channel set by the CH setting switch is available, the control unit 401 displays a use state of the communication channel set by the CH setting switch on the monitor 407 (step S513). At this time, the number of wireless communication terminals using each communication channel included in a communication channel group may be displayed by a numeric value, and a congestion degree of the communication channel may be graphically displayed on the basis of a preset threshold.

Subsequently, the control unit 401 reads a number of a communication channel (any one of the communication channels 1, 6, and 11) set by the CH setting switch from the communication channel setting table, reads communication setting parameters corresponding to the communication channel from the ROM 402, and sets the communication setting parameters to the wireless communication circuit unit 404 (step S514). Subsequently, the receiving device 200 makes the transition to a logical connection phase and executes a process of establishing a logical connection (step S515).

In the logical connection, a state is reached in which a combination of two specific wireless communication terminals, that is, the endoscope 100 and the receiving device 200, among a plurality of communication terminals physically connected is fixed. In this embodiment, if the logical connection is completed, a destination (medium access control (MAC) address) to which the endoscope 100 transmits image data is fixed. In the logical connection phase, the endoscope 100 transmits a MAC address request packet including a MAC address of the endoscope 100, and the receiving device 200 receiving the MAC address request packet transmits a MAC address request response packet including a MAC address of the receiving device 200, so that the MAC addresses are exchanged between the endoscope 100 and the receiving device 200.

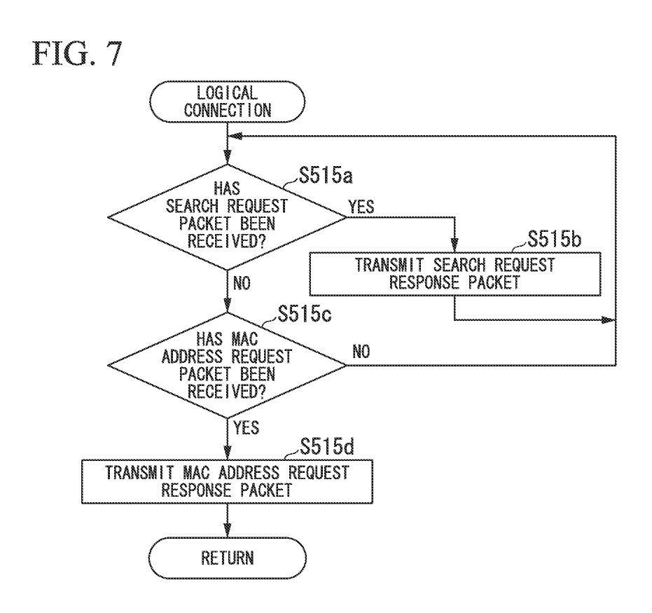

FIG. 7 shows details of step S515 shown in FIG. 5. In the logical connection, first, the control unit 401 determines whether or not the search request packet has been received from another wireless communication terminal after communication channel setup (step S515a). If the search request packet has been received, the control unit 401 causes the wireless communication circuit unit 404 to transmit a search request response packet in a unicast scheme (S515b). Thereafter, the process returns to step S515a. If the search request packet has not been received, the control unit 401 determines whether or not a MAC address request packet has been received from another wireless communication terminal (step S515c). If the MAC address request packet has been received, the control unit 401 causes the wireless communication circuit unit 404 to transmit a MAC address request response packet in a unicast scheme (step S515d). On the other hand, if the MAC address request packet has not been received, the process returns to step S515a.

Returning to FIG. 5, the wireless communication circuit unit 404 starts to receive image data transmitted from the endoscope 100 if the logical connection is completed (step S516).

If it is determined that the communication channel set by the CH setting switch is unavailable in step S512, the control unit 401 reports that a communication environment of the communication channel set by the CH setting switch is bad and unavailable, and causes the monitor 407 to display an alarm message for an instruction to change the CH setting switch (step S517). For example, a message “The set communication channel is unavailable. Please change the CH setting switch,” is displayed on the monitor 407.

Subsequently, the control unit 401 determines whether or not a state of the CH setting switch has been changed (step S518). If the state of the CH setting switch has not been changed, the process of step S517 is re-executed. If the state of the CH setting switch has been changed, the process returns to step S502.

Hereinafter, an operation of the endoscope 100 will be described according to

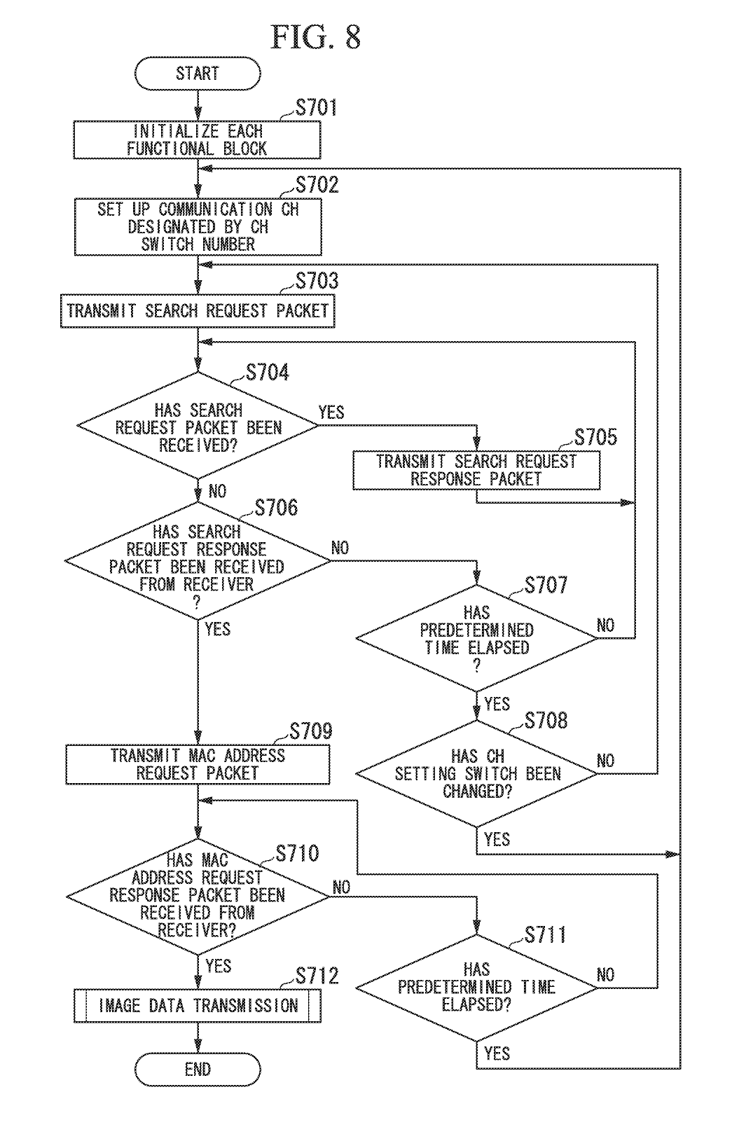

FIG. 8. The operator turns on power of the endoscope 100 after setting a communication channel by the CH setting switch 103 of the endoscope 100 according to a communication channel displayed on the communication setting display unit 201 of the receiving device 200. If the endoscope 100 is powered on, the control unit 301 initializes each functional block of the endoscope 100 (step S701).

Subsequently, the endoscope 100 makes the transition to the search phase of the wireless communication terminal. Upon transition to the search phase, the control unit 301 reads a number of a communication channel (any one of the communication channels 1, 6, and 11) set by the CH setting switch 103 from the search table, reads communication setting parameters corresponding to the communication channel from the ROM 302, and sets the communication setting parameters to the wireless communication circuit unit 306 (step S702). In a search for a wireless communication terminal, a search request packet is transmitted and a search request response packet to the search request packet is received during a predetermined period. Thus, the control unit 401 causes the wireless communication circuit unit 404 to transmit the search request packet in a broadcast scheme (step S703).

After the transmission of the search request packet, the control unit 301 determines whether or not a search request packet from another wireless communication terminal has been received (step S704). If the search request packet has been received, the control unit 301 causes the wireless communication circuit unit 306 to transmit a search request response packet in a unicast scheme (step S705). Thereafter, the process returns to step 5704. If the packet request packet has not been received, the control unit 301 determines whether or not a search request response packet from a receiver has been received (step S706).

If the search request response packet from the receiver has been received, the endoscope 100 makes the transition to a logical connection phase, and executes a process of establishing the logical connection to be described below (steps S709 to S711). That is, the control unit 401 causes the wireless communication circuit unit 404 to transmit a MAC address request packet in a broadcast scheme (step S709). After the transmission of the MAC address request packet, the control unit 301 determines whether or not a MAC address request response packet has been received (step S710). If the MAC address request response packet from the receiver has been received, that is, if the logical connection is completed, the wireless communication circuit unit 306 starts to transmit image data to the receiving device 200 (step S712).

If the search request response packet has not been received, the control unit 401 determines whether or not a predetermined time has elapsed after the transmission of the search request packet in step S703 (step S707). If the predetermined time has not elapsed, the process returns to step S704. If the predetermined time has elapsed, the control unit 401 determines whether or not a state of the CH setting switch 103 has been changed (step S708). If the state of the CH setting switch 103 has not been changed, the process returns to step S703. If the state of the CH setting switch 103 has been changed, the process returns to step S702.

Likewise, if the MAC address request response packet has not been received, the control unit 401 determines whether or not a predetermined time has elapsed after the transmission of the MAC address request response packet of step S709 (step S711). if the predetermined time has not elapsed, the process returns to step S710. If the predetermined time has elapsed, the process returns to step S702.

In the first operation example, the control unit 401 of the receiving device 200 selects a communication channel group designated by the CH setting switch (step S503). The control unit 401 detects a use state of a communication channel belonging to the communication channel group (the number of peripheral wireless communication terminals using the same communication channel (any one of the communication channels 1, 6, and 11) as the communication channel set by the CH setting switch or using a communication channel having a use frequency band overlapping that of the communication channel set by the CH setting switch) (steps S504 to S511). Furthermore, the control unit 401 determines whether or not to perform communication using the communication channel belonging to the selected communication channel group on the basis of a detection result of the use state of the communication channel (step S512).

As described above, it is possible to efficiently select a communication channel having a good communication state by detecting the use state of only the communication channel belonging to the communication channel group. Furthermore, it is possible to shorten a connection waiting time of the endoscope 100 driven by a battery and implement power saving by turning on the power of the endoscope 100 after a communication channel to be used by the receiving device 200 is fixed. It is possible to reduce the occurrence of a communication error because a communication channel in which radio wave interference is not easily generated for communication channels used by peripheral wireless communication terminals is selected in the determination of step S512.

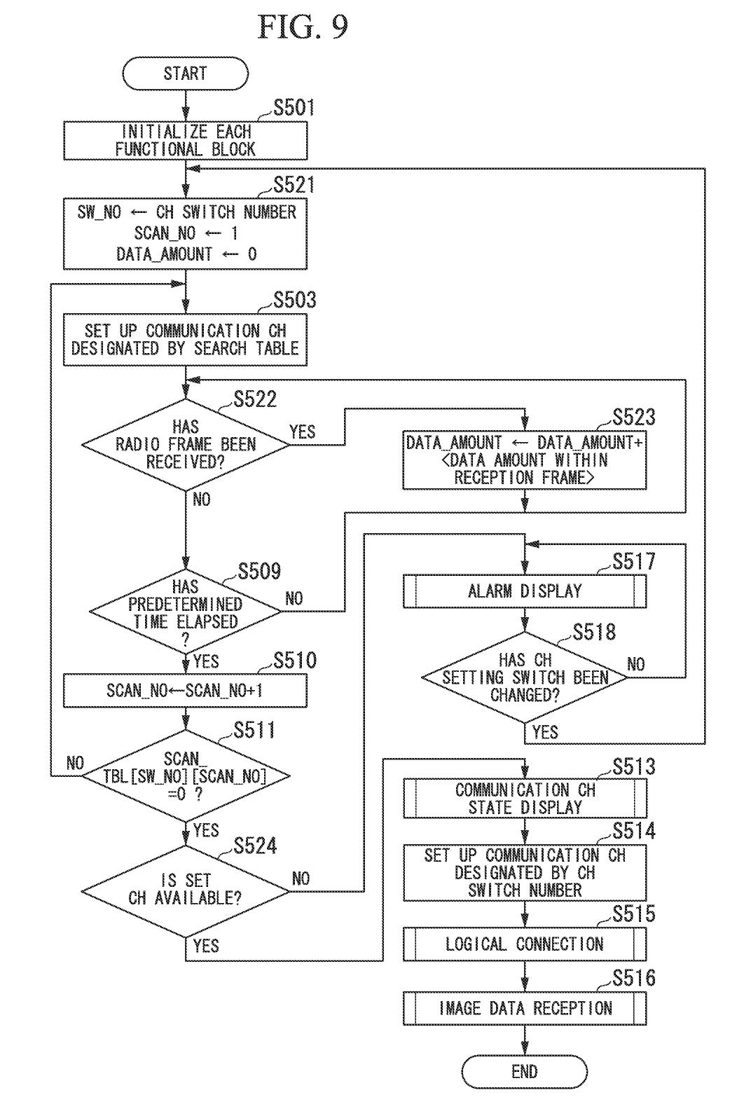

Next, a second operation example will be described. Because an operation of the endoscope 100 in the second operation example is the same as in the first operation example, a description thereof is omitted. Hereinafter, an operation of the receiving device 200 will be described according to FIG. 9. In FIG. 9, the same processes as those shown in FIG. 5 are denoted by the same step numbers. Hereinafter, only steps different from those shown in FIG. 5 will be described.

After the process of step S501, the control unit 401 initializes parameters SW_NO, SCAN_NO, and DATA_AMOUNT to be later used in control (step S521). SW_NO is a parameter for storing a CH switch number, and is stored as a CH switch number set by the CH setting switch during initialization. SCAN_NO is a parameter for storing a search order in the search table, and is stored as 1 during the initialization. DATA_AMOUNT is a parameter for storing a data amount.

After the process of step S521, the process proceeds to step S503. After the process of step S503, the control unit 401 determines whether or not a radio frame from another wireless communication terminal has been received (step S522). If the radio frame from another wireless communication terminal has been received, the control unit 401 adds a data amount within the received frame to the value of DATA_AMOUNT and updates the value (step S523). After the process of step S523, the process returns to step S522. If the radio frame from another wireless communication terminal has not been received, the process proceeds to step S509.

If a number of a communication channel designated by SW_NO and SCAN_NO after the update is 0 in step S511, the control unit 401 determines whether or not the communication channel set by the CH setting switch is available (step S524). While the value of TERM_NUM[SW_NO] is used in the determination in step S512 of FIG. 5, the value of DATA AMOUNT is used in the determination in step S524 of FIG. 9. The value of DATA_AMOUNT indicates an amount of data transmitted using the same communication channel (any one of the communication channels 1, 6, and 11) as the communication channel set by the CH setting switch or using a communication channel having a use frequency band overlapping that of the communication channel set by the CH setting switch.

If the value of DATA AMOUNT counted in step S523 is less than a predetermined threshold, the control unit 401 determines that the communication channel set by the CH setting switch is available. If it is determined that the communication channel set by the CH setting switch is available, the process proceeds to step S513. If it is determined that the communication channel set by the CH setting switch is unavailable, the process proceeds to step S517.

In the second operation example, the control unit 401 of the receiving device 200 selects a communication channel group designated by the CH setting switch (step S503). The control unit 401 detects a use state of a communication channel belonging to the communication channel group (an amount of data transmitted using the same communication channel as the communication channel set by the CH setting switch or using a communication channel having a use frequency hand overlapping that of the communication channel set by the CH setting switch) (steps S522, S523, and S509 to S511). Furthermore, the control unit 401 determines whether or not to perform communication using the communication channel belonging to the communication channel group (step S524).

Therefore, in the second operation example, it is also possible to efficiently select a communication channel having a good communication state and implement power saving of the endoscope 100. Also, it is possible to reduce the occurrence of a communication error.

Next, a third operation example will be described. In the third operation example, an automatic mode in which the receiving device 200 can automatically select a communication channel is provided in addition to a mode in which the operator can manually select the CHs 1 to 3 by the CH setting switch. Thus, a switch by which the automatic mode is selectable is added to the operation unit 408 of the receiving device 200.

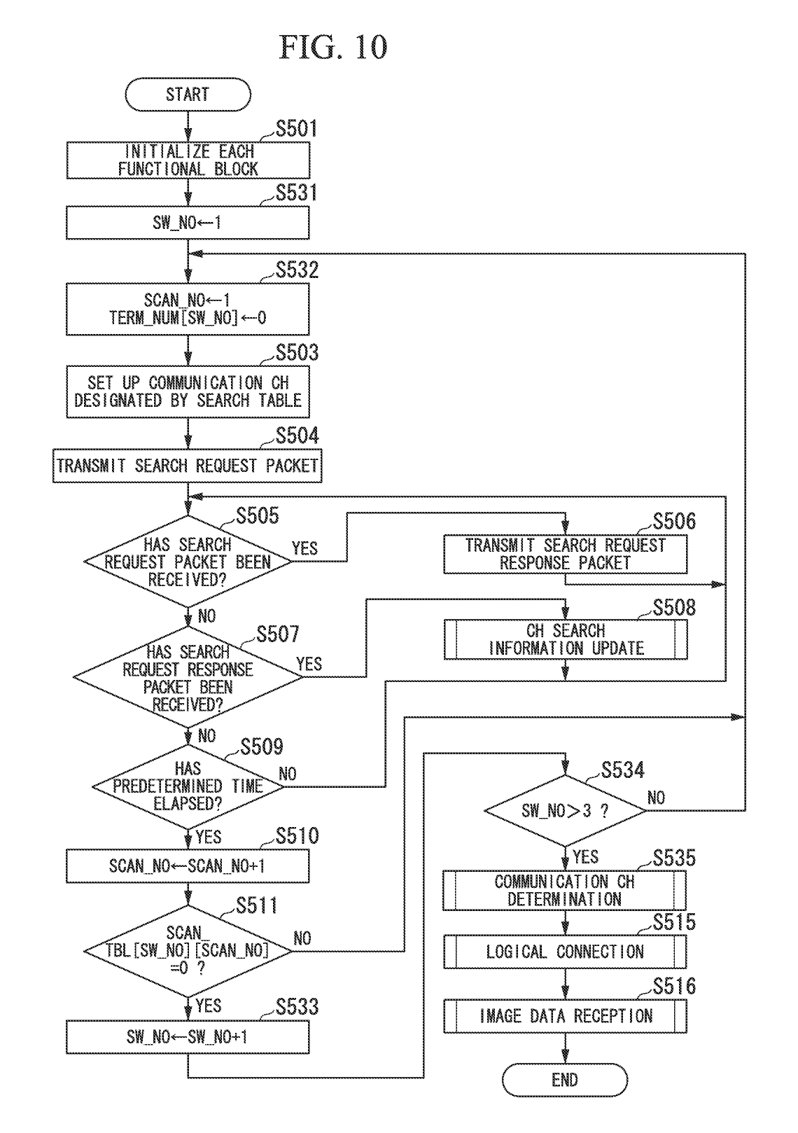

Because the operation of the endoscope 100 in the third operation example is the same as in the first operation example, description thereof is omitted. Hereinafter, an operation of the receiving device 200 in the automatic mode will be described according to FIG. 10. In FIG. 10, the same processes as those shown in FIG. 5 are denoted by the same step numbers. Hereinafter, only steps different from those shown in FIG. 5 will be described.

After the process of step S501, the control unit 401 initializes a parameter SW_NO to be later used in control (step S531), and further initializes parameters SCAN_NO and TERM_NUM[SW_NO] (step S532). SW_NO is a parameter for storing a CH switch number, and is stored as 1 during initialization. SCAN_NO is a parameter for storing a search order in the search table, and is stored as 1 during the initialization. TERM_NUM[SW NO] is a parameter for storing the number of peripheral wireless communication terminals using a communication channel satisfying a predetermined condition, and is stored as 0 during the initialization. TERM_NUM[SW NO] includes three values of TERMNUM[1], TERM_NUM[2], and TERM_NUM[3].

In the first operation example, at this time, an LED corresponding to the set communication channel is turned on in the communication setting display unit 201 to indicate communication setting set by the CH setting switch. However, at this time in the third operation example, the LED of the communication setting display unit 201 is in a turn-off state because a communication channel to be used is not fixed.

If a number of a communication channel designated by SW_NO and SCAN_NO after update is 0 in step S511, the control unit 401 adds 1 to the value of SW_NO and updates the value (step S533). Subsequently, the control unit 401 determines whether or not the value of SW_NO exceeds 3 (step S534).

If the value of SW_NO is equal to or less than 3, the process returns to step S532. If the value of SW_NO exceeds 3, the control unit 401 determines a communication channel to be used on the basis of the value of TERM NUM[SW_NO]. Specifically, the control unit 401 compares the number of wireless communication terminals, TERMNUM[1], TERM_NUM[2], and TERM_NUM[3], counted in step S508 for each selectable communication channel, and determines a communication channel corresponding to the smallest number of wireless communication terminals as the communication channel to be used (step S535).

Specifically, the communication channel 1 corresponding to the CH switch number 1 is selected if TERM NUM[1] is smallest, the communication channel 6 corresponding to the CH switch number 2 is selected if TERM_NUM[2] is smallest, and the communication channel 11 corresponding to the CH switch number 3 is selected if TERM_NUM[3] is smallest. After the process of step S535, the process proceeds to step S515. Because the process of step S515 is the same as described above with reference to FIG. 7, description thereof is omitted. At this time, communication setting parameters of the determined communication channel are set in the wireless communication circuit unit 404, and an LED corresponding to the set communication channel is turned on in the communication setting display unit 201.

Therefore, in the third operation example, it is also possible to efficiently select a communication channel having a good communication state and implement power saving of the endoscope 100. Also, it is possible to reduce the occurrence of a communication error.

Next, a fourth operation example will be described. In the fourth operation example, like the third operation example, an automatic mode in which the receiving device 200 can automatically select a communication channel is provided in addition to a mode in which the operator can manually select the CHs 1 to 3 by the CH setting switch.

In the fourth operation example, a method shown in the second operation example is used as a method of detecting a use state of the communication channel.

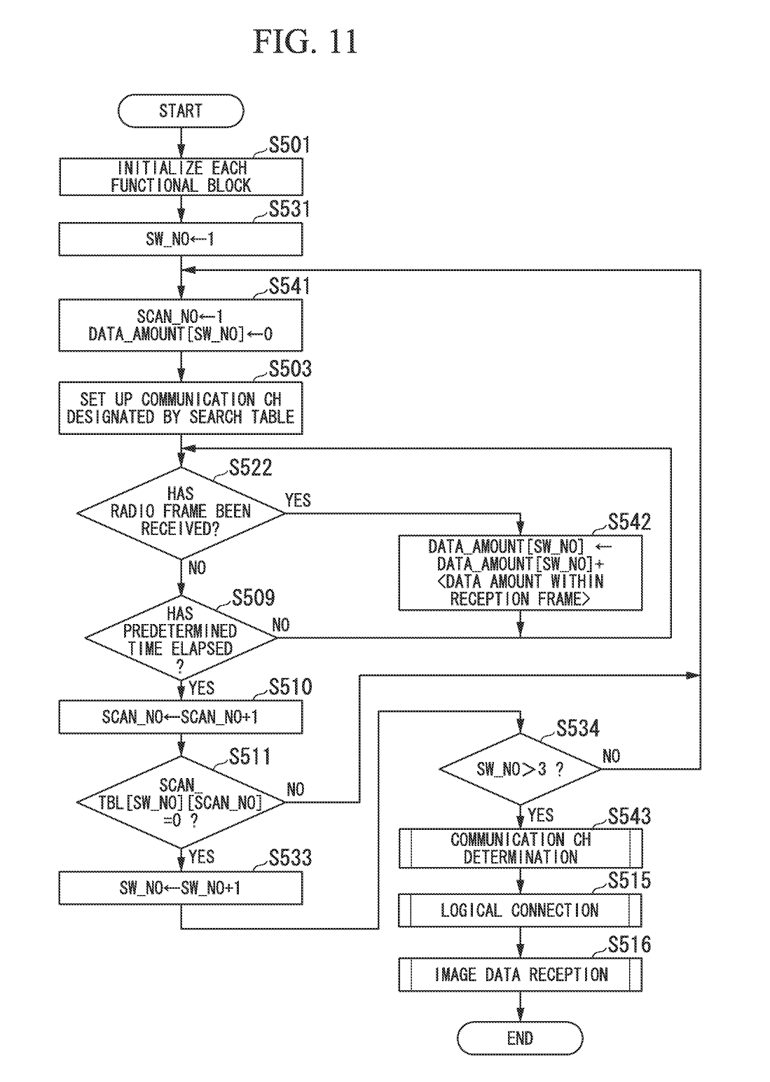

Because the operation of the endoscope 100 in the fourth operation example is the same as in the first operation example, description thereof is omitted. Hereinafter, an operation of the receiving device 200 in the automatic mode will be described according to FIG. 11. In FIG. 11, the same processes as those shown in FIGS. 9 and 10 are denoted by the same step numbers. Hereinafter, only steps different from those shown in FIGS. 9 and 10 will be described.

After the process of step S531, the control unit 401 initializes parameters SCAN_NO and DATA AMOUNT[SWNO] to be later used in control (step S541). SCAN_NO is a parameter for storing a search order in the search table, and is stored as 1 during initialization. DATA_AMOUNT[SW_NO] is a parameter for storing a data amount, and is stored as 0 during the initialization. DATA_AMOUNT[SW_NO] includes three values of DATA AMOUNT[1], DATA_AMOUNT[2], and DATA AMOUNT[3].

If a radio frame from another wireless communication terminal has been received in step S522, the control unit 401 adds a data amount within the received frame to the value of DATA_AMOUNT[SW_NO], and updates the value (step S542). After the process of step S542, the process returns to step S522. If the radio frame from another wireless communication terminal has not been received, the process proceeds to step S509.

If the value of SW NO exceeds 3 in step S534, the control unit 401 determines a communication channel to be used on the basis of the value of DATA AMOUNT[SW NO]. Specifically, the control unit 401 compares DATA AMOUNT[1], DATA_AMOUNT[2], and DATA AMOUNT[3] counted in step S542 for each selectable communication channel, and determines a communication channel corresponding to a smallest value as the communication channel to be used (step S543).

Specifically, the communication channel 1 corresponding to the CH switch number 1 is selected if DATA AMOUNT[1] is smallest, the communication channel 6corresponding to the CH switch number 2 is selected if DATA_AMOUNT[2] is smallest, and the communication channel 11 corresponding to the CH switch number 3 is selected if DATA AMOUNT[3] is smallest. After the process of step S543, the process proceeds to step S515. Because the process of step S515 is the same as described above with reference to FIG. 7, description thereof is omitted. At this time, communication setting parameters of the determined communication channel are set in the wireless communication circuit unit 404, and an LED corresponding to the set communication channel is turned on in the communication setting display unit 201.

In the fourth operation example, it is also possible to efficiently select a communication channel having a good communication state and implement power saving of the endoscope 100. Also, it is possible to reduce the occurrence of a communication error.

In the above-described four operation examples, a communication channel set by the CH setting switch and all communication channels each having a use frequency band partially overlapping that of the set communication channel are objects of which communication states are to be sensed as a communication channel group. On the other hand, as shown in FIG. 18, it is possible to further shorten a time in which it is determined whether or not a communication channel is available by excluding a communication channel having a small overlap range in a frequency band and small radio wave interference to the communication channel (for example, the communication channel 1) set by the CH setting switch from the objects of which communication states are to be sensed.

In this case, the communication channel setting table becomes as shown in FIG. 14, and the search table becomes as shown in FIG. 15. Although FIGS. 12 and 13 include communication channels (the communication channels 3, 4, 8, and 9) belonging to two different communication channel groups, all communication channels in FIGS. 14 and 15 belong to only one communication channel group.

According to this embodiment as described above, a use state of a communication channel belonging to a selected communication channel group is detected, and it is determined whether or not to perform communication using the communication channel belonging to the selected communication channel group on the basis of a detection result. Thereby, it is possible to efficiently select a communication channel having a good communication state as compared to the case where all communication channels are searched for. Furthermore, it is possible to shorten a connection waiting time of the endoscope 100 driven by the battery and implement power saving by turning on the power of the endoscope 100 after a communication channel to be used by the receiving device 200 is fixed. Furthermore, it is possible to reduce the occurrence of a communication error because a communication channel in which radio wave interference is not easily generated for communication channels used by peripheral wireless communication terminals is selected.

If the communication channel set by the CH setting switch is unavailable, a message for an instruction of a change of the CH setting switch is displayed on the monitor 407 to prompt selection of a communication channel group different from the selected communication channel group (step S517). Thereby, the operator can easily know when to change a communication channel to be used in the logical connection.

If the communication channel set by the CH setting switch is available and the communication using the communication channel is determined to be performed, information regarding a use state of the communication channel to be used is displayed on the monitor 407 (step S513). Thereby, the operator can know the use state of the communication channel to be used. In the operations shown in FIGS. 5 and 9, a determination of a state of the CH setting switch as in step S518 is made after step S513. If the state of the CH setting switch has been changed, the process from step S502 may be re-executed. Thereby, if there is a communication channel having a better communication state than a communication channel determined to be available, it is possible to select the communication channel having the better communication state.

To detect the use state of the communication channel, a reception level (received signal strength) or communication traffic (data amount) of a communication channel belonging to a selected communication channel group is detected (steps S508, S523, and S542). Thereby, it is possible to easily detect the use state of the communication channel.

In the first operation example, TERM_NUM[SWNO]=0 (SW_NO=1, 2, or 3) if there is no other wireless communication terminal using the same communication channel (any one of the communication channels 1, 6, and 11) as the communication channel set by the CH setting switch and there is no other wireless communication terminal using a communication channel having a use frequency band overlapping that of the communication channel set by the CH setting switch. At this time, it is possible to select a communication channel having a good communication state by use of the communication channel set by the CH setting switch.

In the second operation example, it is possible to select a communication channel having a good communication state by use of the communication channel set by the CH setting switch when detected communication traffic (data amount) is less than a predetermined value.

It is possible to select a communication channel having the best communication state by use of a communication channel corresponding to a smallest value of TERM_NUM[SW_NO] (SW_NO=1, 2, 3), which is the number of peripheral wireless communication terminals using a communication channel satisfying a predetermined condition.

In the fourth operation example, it is possible to select a communication channel having the best communication state by use of a communication channel corresponding to a smallest value of a data amount DATA AMOUNT [SW_NO] (SW_NO=1, 2, 3) of a specific communication channel.

In the communication channel setting table shown in FIG. 14, as compared to the communication channel setting table shown in FIG. 12, communication channels (for example, the communication channels 3 and 9) each having an overlap of a use frequency band with that of the communication channel (for example, the communication channel 6) set by the CH setting switch that is equal to or less than a predetermined range are excluded. As a result, each of individual communication channels belonging to each communication channel group (for example, the communication channels 2 and 3 corresponding to the CH switch number 1) is set to have a use frequency band, which does not overlap those of communication channels belonging to other communication channel groups (for example, the communication channel 6 corresponding to the CH switch number 2 and the communication channel 11 corresponding to the CH switch number 3) set by the CH setting switch. Thereby, because a communication channel having a small influence on radio wave interference to the communication channel set by the CH setting switch is excluded from each communication channel group in FIG. 14, the number of communication channels belonging to an individual communication channel group is less than in FIG. 12. Therefore, it is possible to efficiently select a communication channel in which occurrence radio wave interference is difficult.

As shown in FIGS. 12 and 13, communication channels (for example, the communication channels 3, 4, 5, 7, 8, and 9) each having an overlap of a use frequency hand with that of a communication channel (for example, the communication channel 6) set by the CH setting switch that is equal to or greater than a predetermined range (about 5 MHz or more in this embodiment) are set to belong to the same communication channel group so that it is possible to efficiently detect a use state of a communication channel in which radio wave interference with a communication channel (for example, the communication channel 6) to be used occurs. Therefore, it is possible to efficiently select a communication channel having a good communication state.

Although the embodiments of the present invention have been described above in detail with reference to the drawings, specific configurations are not limited to those of the embodiments. Design changes and the like are encompassed without departing from the spirit of the present invention.

### INDUSTRIAL APPLICABILITY

The present invention is applicable in wireless communication based on a wireless communication system such as a wireless LAN.

### DESCRIPTION OF THE REFERENCE SYMBOLS

100 Endoscope (Transmitting device)

101 Power switch

102 Operating switch

103 CH setting switch

104 State indication LED

200 Receiving device

201 Communication setting display unit

301, 401 Control unit (Determination unit)

302, 402 ROM (Storage unit)

303, 403 RAM

304 Image pickup unit

305 Illumination unit

306, 404 Wireless communication circuit unit (Communication unit)

307, 405 Antenna

308, 408 Operation unit

406 Image signal processing unit

407 Monitor (Output unit)

1. A receiving device of a wireless endoscopic apparatus comprising:
a communication unit that communicates with a transmitting device by using a communication channel selected from among n (n>1) communication channels, each of the communication channels having a use frequency band partially overlapping at least one other communication channel, the communication unit receiving image data transmitted from the transmitting device;
a storage unit that stores x (1<x≦n) communication channel groups to which L (1≦L<n) communication channels belong; and
a determination unit that selects any communication channel group from among the communication channel groups stored by the storage unit, the determination unit performing a detection of use states of a communication channel scheduled for use in receipt of the image data among communication channels belonging to the selected communication channel group and an adjacent communication channel belonging to the selected communication channel group adjacent to the communication channel scheduled for use, the determination unit determining whether or not to perform communication using the communication channel scheduled for use based on results of the detection.

2. The receiving device of the wireless endoscopic apparatus according to claim 1, further comprising:
an output unit that outputs information for prompting selection of a communication channel group that is different from the selected communication channel group if the determination unit determines not to perform the communication.

3. The receiving device of the wireless endoscopic apparatus according to claim 2, wherein if the determination unit determines to perform the communication, then the output unit outputs information regarding a use state of a communication channel to perform the communication.

4. The receiving device of the wireless endoscopic apparatus according to claim 2, further comprising:
a operation unit that allows an operator to select a communication channel group and transfers a selection result to the determination unit.

5. The receiving device of the wireless endoscopic apparatus according to claim 1, wherein the determination unit detects communication traffic of a communication channel belonging to the selected communication channel group as the use state.

6. The receiving device of the wireless endoscopic apparatus according to claim 1, wherein the determination unit detects received signal strength of a communication channel belonging to the selected communication channel group as the use state.

7. The receiving device of the wireless endoscopic apparatus according to claim 5, wherein the determination unit determines whether or not to perform communication using the communication channel belonging to the selected communication channel group based on presence of a communication channel of which communication traffic is less than a predetermined threshold.

8. The receiving device of the wireless endoscopic apparatus according to claim 6, wherein the determination unit determines whether or not to perform communication using the communication channel belonging to the selected communication channel group based on presence of a communication channel of which the received signal strength is less than a predetermined threshold.

9. The receiving device of the wireless endoscopic apparatus according to claim 5, wherein the determination unit determines to perform communication using a communication channel belonging to a communication channel group having a smallest total of communication traffic of communication channels belonging to the same communication channel group.

10. The receiving device of the wireless endoscopic apparatus according to claim 1, wherein the storage unit stores a communication channel group to which a communication channel having a use frequency band not overlapping that of a specific communication channel belonging to which another communication channel group belongs.

11. The receiving device of the wireless endoscopic apparatus according to claim 1, wherein the storage unit stores a communication channel group to which a communication channel having an overlap of a use frequency band with that of a specific communication channel belonging to the same communication channel group belongs, wherein the overlap is equal to or greater than a predetermined range.

12. A receiving method for use in a receiving device of a wireless endoscopic apparatus, comprising the steps of:
selecting any communication channel group from among x (1<x≦n) communication channel groups to which L (1≦L<n) communication channels belong among n (n>1) communication channels each having a use frequency band partially overlapping that of at least one other communication channel;
detecting use states of a communication channel scheduled for use in receipt of the image data among communication channels belonging to the selected communication channel group and an adjacent communication channel belonging to the selected communication channel group adjacent to the communication channel scheduled for use;
determining whether or not to perform communication using the communication channel scheduled for use on the basis of detection results; and
communicating with the transmitting device by use of a communication channel when determining to perform communication using the communication channel belonging to the selected communication channel group, and receiving image data transmitted from the transmitting device.

13. A wireless endoscopic apparatus comprising a receiving device and a transmitting device, wherein:
the receiving device comprises:
a first communication unit that communicates with a transmitting device by use of a communication channel selected from among n (n>1) communication channels each having a use frequency band partially overlapping that of at least one other communication channel, the communication unit receiving image data transmitted from the transmitting device;
a storage unit that stores x (1<x≦n) communication channel groups to which L (1≦L<n) communication channels belong; and
a determination unit that selects any communication channel group from among the communication channel groups stored by the storage unit, the determination unit detecting use states of a communication channel scheduled for use in receipt of the image data among communication channels belonging to the selected communication channel group and an adjacent communication channel belonging to the selected communication channel group adjacent to the communication channel scheduled for use, the determination unit determining whether or not to perform communication using the communication channel scheduled for use on the basis of detection results, and
the transmitting device comprises:
a second communication unit that communicates with the receiving device by use of a communication channel selected from among n communication channels and transmits the image data to the receiving device.
